(19) United States
(12) Patent Application Publication
(10) Pub. No.: US 2009/0048894 A1
(43) Pub. Date: Feb. 19, 2009

(54) TECHNIQUES FOR PROPAGATING CHANGES IN PROJECTS

(76) Inventors: Michel Shane Simpson, American Fork, UT (US); Volker Gunnar Scheuber-Heinz, Pleasant Grove, UT (US); Lee Edward Lowry, Orem, UT (US); Stephen R. Carter, Spanish Fork, UT (US)

Correspondence Address: SCHWEGMAN, LUNDBERG & WOESSNER/NOVELL, PO BOX 2938, MINNEAPOLIS, MN, 55402, US

(21) Appl. No.: 11/838,513

(22) Filed: Aug. 14, 2007

(51) Int. Cl. G06F 9/00

(52) U.S. Cl. 705/9

(57) ABSTRACT

Techniques for propagating changes in projects are provided. A first resource associated with a first project is modified in some manner. The modification is automatically and dynamically detected. A second project is identified for notification of that change. The notification is communicated to the second project in a custom manner.

### BACKGROUND

Increasingly enterprises and governments are turning to technology to automate and streamline their internal operations and business processes. Furthermore, the advent of the Internet and the World-Wide Web (WWW) has allowed enterprises and governments to deliver goods and services in an automated and nearly instantaneous fashion across the entire globe.

With any good or service provided by an enterprise or a government, there can be potentially a myriad of activities and expenses associated with those activities, which the enterprise or government endures before the good or service is available in the marketplace for consumption.

For example, word processing software has to be initially defined, developed and tested before it can be released for sale. These activities are usually managed internally by high-salaried project managers. For the most part, the project managers are administrators with skill in acquiring other personnel and equipment within an enterprise to make a project move from conception and development to release. In some cases, projects are so large within an enterprise that multiple layers of project managers are needed for any given project.

In large part, the industry has not been able to successfully automate and streamline the project management process. As a result, the cost of goods and services are likely unduly inflated and the time-to-market for goods and services is longer than it probably should be.

One reason for this lack of automation is the perceived complexity associated with project management in general. There are a variety of considerations such as laws, regulations, internal procedures that have to be followed. In addition, there may be limited personnel with specific skill sets some of which may be in high demand and unavailable within the enterprise and some of which the enterprise does not have and will have to contract out or hire in order to obtain.

Moreover, a variety of other complicating factors can affect released software project or portions of a project still in development. For example, a new release of a third-party application or Application Programming Interface (API) may occur, an enhancement to a product may occur, a bug fix may occur, a new government regulation may be enforced, a new industry standard may be enforced, etc. Conventionally, when these types of circumstances occur all of the various systems and application that use the changes have to be manually identified and updated, if at all, to conform with those changes. As is apparent, this can be fraught with manual error, spotty enforcement, and other support issues.

Thus, what is needed is an automated and flexible mechanism, which allows for improved coordination between projects and between portions of a same project.

### SUMMARY

In various embodiments, techniques for propagating changes in projects are provided. More specifically, and in an embodiment, a method is provided for detecting and communicating a modification to a project to a different project. A modification to a resource of a first project is detected. The resource is within a source stage of a lifecycle for the first project and within a source processing environment. Next, a second project is determined for receiving the notification of the modification. Finally, the notification regarding the modification is communicated to the second project.

### BRIEF DESCRIPTION OF THE DRAWINGS

FIG. 1 is a diagram of a method for detecting and communicating a modification to a project to a different project, according to an example embodiment.

FIG. 2 is a diagram of a method for receiving notification of a modification to a project and taking action in a different project, according to an example embodiment.

FIG. 3 is a diagram of a project modification detection and communication system, according to an example embodiment.

FIG. 4 is a diagram of a project modification action system, according to an example embodiment.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, content, a World-Wide Web (WWW) service, a WWW page, groups of users, a digital certificate, an attestation, combinations of these things, etc. The terms “service,” “application,” and “system” may be used interchangeably herein and refer to a type of software resource that includes instructions, which when executed by a machine performs operations that change the state of the machine and that may produce output.

A “principal” is a special type of resource that performs one or more actions against other resources. So a principal may be a user or an automated service.

In an embodiment, each resource is electronically defined and represented as having one or more attributes. Each attribute includes one or more name value pairs. For example, a server resource may include an attribute associated with its physical Internet Protocol (IP) address and that attribute may be represented by the following name value pair: “IP=100.1.1.10.” The server resource may also have its own identity (discussed below) and may include other attributes such as whether the IP address is static or dynamic, etc. Attributes may also include references to policy or even specific configuration details for a given processing environment that a resource is to be deployed to.

A “project” refers to the activity associated with an enterprise or government producing a good (product) or personal service (e.g., financial advice, etc.) for consumption in the marketplace. The activity for the project is defined in various stages of the project's lifecycle, such as by way of example only project definition, project development, project testing, project release, etc. Thus, a “project” is represented and electronically defined as a series of stages associated with the project's lifecycle. Each stage includes its own processing environment having its own or shared resources. So, a stage is represented and electronically defined as one or more resources and their relationships with other resources of the same stage or a different stage. A project may also be viewed as a type of resource.

A virtual project is one that includes other sub projects or nested projects. Some resources associated with a virtual project may be instantiated and ready for use while others are configured and instantiated according to policy.

Projects and virtual projects are defined via configuration data, metadata, policy, and other directives or statements that can be interpreted by and acted upon by other services or resources to logically assemble and define a collection of resources as a particular project or meta resource. As used here a project can include one or more virtual projects or references to nested sub and independent projects.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

A “modification” is a change that occurs in a resource. A change can be adding a new resource to a processing environment where it did not previously exist, an update to a resource, a bug fix to a resource, an alteration to procedures associated with a resource, an alteration to regulations associated with a resource, etc.

A “notification” is a communication regarding a modification. The notification can be a simple event communication or it can be more complex and include a variety of information with the notification, such as but not limited to an identity of a project, a modification type, an identity of a resource, a procedure to take in response to the notification, etc.

Various embodiments of this invention can be implemented in existing network architectures, security systems, data centers, and/or communication devices. Any particular architectural layout or implementation presented herein is provided for purposes of illustration and comprehension only and is not intended to limit aspects or embodiments of the invention.

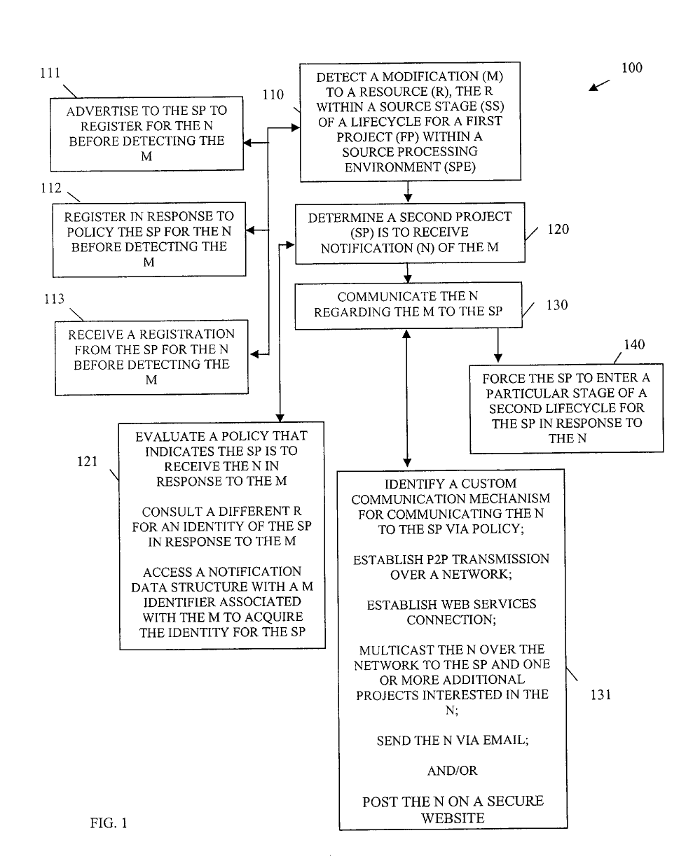

It is within this context, that various embodiments of the invention are now presented with reference to the FIGS. 1-4.

FIG. 1 is a diagram of a method 100 for detecting and communicating a modification to a project to a different project, according to an example embodiment. The method 100 (hereinafter “detection and communication service”) is implemented as instructions in a machine-accessible and readable medium. The instructions when executed by a machine perform the processing depicted in FIG. 1. The detection and communication service is also operational over and processes within a network. The network may be wired, wireless, or a combination of wired and wireless.

As will be more fully described herein and below, the detection and communication service permits modification to resources of a project's lifecycle within a particular stage of that lifecycle to be automatically and dynamically detected. The modification is also communicated to other projects associated with other independent stages of their own lifecycle and processing in different processing environments.

At 110, the detection and communication service detects a modification to a resource. The resource is located within a source stage of a lifecycle for a first project. The resource processes within a source processing environment. Detection of the modification can occur in a variety of manners.

For example, the resource may include triggers that automatically raise an event. In another case, actions of a resource or actions taking on the resource can be monitored to detect a modification. For example, an update action can be assumed to be a modification to the resource. A modification may also be automatically assumed if the resource is newly added for a first time to the source processing environment.

In an embodiment, at 111, the detection and communication service advertises to a second project. The advertisement is for the second project, via a second project service, to register for notification of a particular modification or any modification made to the resource or to the first project as a whole. This advertisement occurs before the modification is detected.

In some cases, the advertisement may be done via an interface that a principal associated with the second project interacts with, such as but not limited to a World-Wide Web (WWW) site. It is noted that this is but one example, other examples exists as well and some of them may be entirely automated, such as service-to-service interaction.

In another embodiment, at 112, the detection and communication service actively registers, in response to policy, the second project for the notification before detecting the modification to the resource. Here, a schema definition for the resource or the first project can define that a particular project, such as the second project is to be dynamically and automatically registered for modifications to the resource or the first project as a whole. The schema definition includes the policy for registering the second project. So, the registration of the second project can be voluntary, such as when done in response to the advertisement processing, at 111; or the registration can be automatically forced upon the second project, such a via schema definitions for the projects and/or policy requirements. The schema definition approach permits independent project having a share or common resource of interest to maintain a dependent relationship.

In another situation, at 113, the detection and communication service receives a registration from the second project, via a principal of the second project or via an automated service associated with the second project. The registration is for notification regarding modifications to the resource or the first project as a whole, which includes the resource. Receipt of this registration may come in response to the advertisement process or may come entirely unsolicited.

It is noted that unsolicited registration may also include security procedures, since in some instances policy and/or access restrictions may not permit some unsolicited registrations.

At 120, the detection and communication service determines that a particular second project is to receive notification of the modification that occurred to the resource of the first project. Determining a particular second project, second principal or second service associated with the second project can occur in a variety of manners.

For example, at 121, the detection and communication service may evaluate a policy that indicates the particular second project is to receive the notification in response to detection of the modification to the resource. In another case, the detection and communication service may consult a different resource for an identity of the second project and to resolve the second project. This may occur via an identity service, such as the identity service discussed in detail above and incorporated by reference herein and above. In still another situation, the detection and communication service may access a notification data structure with a modification identifier, which is associated with the modification, to acquire the identity for the second project. The data structure may be a file, a table, a database table, a directory, user-defined structure, etc.

At 130, the detection and communication service communicates the notification of the modification made to the resource to the second project. Again, this communication and the method of communication can occur in a variety of custom and configurable manners.

For example, at 131, the detection and communication service can identify a custom communication mechanism for communicating the notification the second project via policy. Any user-defined communication mechanism can be used, such as but not limited to service-to-service notification, instant message, text message, etc. Another example includes establishing Web Services connection or even a peer-to-peer (P2P) transmission over network between the detection and communication service and the second project or a service of the second project. In still another case, the detection and communication service can multicast the notification over the network to the second project and to one or more additional projects interested in and registered for the notification. In another situation, the detection and communication service can send an email to a second principal associated with the second project. In yet another case, the detection and communication service can post the notification to a secure website accessible to the second project via a second principal or an automated service that is capable of accessing the web site. A variety of access mechanisms can be used, such as but not limited to web site scraping, accessing the web site source, Simple Object Access Protocol (SOAP) messages, etc.

According to an embodiment, at 140, the detection and communication service forces the second project to enter a particular stage or a second lifecycle associate with the second project in response to the notification. Again, such a situation can occur if policy dictates that one or more services in the second processing environment are associated with the second project.

It is noted that the first processing environment and the second processing environment are different from one another and external over a wide-area network from one another, such as the Internet or the WWW. In some cases, the first processing and second processing environments can be local or internal to a specific and same processing environment, such as when virtual machines are carved out of a single machine and overall processing environment. In such a case, the two processing maybe said to be logically external to one another but physically they are local or internal to a specific machine and processing environment.

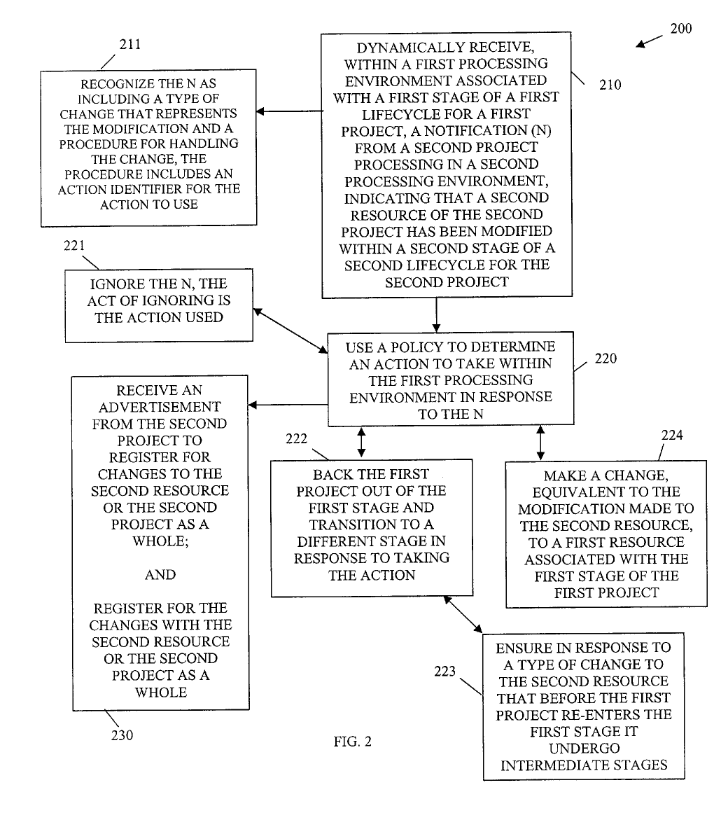

FIG. 2 is a diagram of a method 200 for receiving notification of a modification to a project and taking action in a different project, according to an example embodiment. The method 200 (hereinafter “modification action service”) is implemented as instructions in a machine-accessible and readable medium. The instructions when executed by a machine perform the processing depicted in FIG. 2. The modification action service is also operational over and processes within a network. The network may be wired, wireless, or a combination of wired and wireless.

The modification action service represents the processing that the detection and communication service, represented by the method 100 discussed above with the FIG. 1, interacts with to receive project modifications from one project and to take actions in an entirely different project. Each project associated with different processing environments.

At 210, the modification action service dynamically receives a notification from a second project. The modification action service processes within a first processing environment and in the context of first stage associated with a first lifecycle of a first project. Conversely, the second project exists over a wide-area network (WAN) and is associated with a second stage of second lifecycle, which processes within a second processing environment. The notification received is an indication that a second resource has been modified within the second stage of the second project.

In an embodiment, at 211, the modification action service recognizes the notification as including a variety of beneficial processing information. For example, the notification may include a type of change that represents the modification and a procedure for handling the change within the first project of the first processing environment. The procedure can also include an action identifier or action reference that identifies an action for the modification action service to use in response to receipt of the notification.

At 220, the modification action service uses a policy to determine an action to take within the first processing environment to take in response to the notification. A variety of actions can be taken.

For example, at 221, the modification action service ignores the notification. The act of ignoring is the action taken by the modification action service.

In another case, at 222, the modification action service backs the first project out of the first stage and forces a transition to a different stage associated with the first project. The different stage is associated with yet another and different processing environment. At 223, the modification action service may also enforce or ensure in response to a type of change associated with the second resource and the notification that before the first project is permitted to re-enter the first stage that the first project undergo other intermediate changes, such as quality assurance, testing, certification, etc.

In yet another example of an action to use, at 224, the modification action service makes a change, which is equivalent to the modification made to the second resource, to a corresponding first resource, associated with the first stage of the first project. So, the modification action service can automatically and dynamically ensure the modification that occurred in the second resource is synchronized in the first resource of the first processing environment. For example, a third-party software library that is being upgraded can be automatically updated and installed in the first processing environment. It is noted that the adjectives “first” and “second” are being used to denote different projects, their resources, their stages, and their processing environments. The use of “first” and “second” is not intended to suggest a particular sequential order associated with the stages. So, a in some cases a first stage may actually be downstream from the second stage. That is, the second stage can be an initial stage for the second project while the first stage is actually a last stage for the first project. So, sequential order is not to be implied by the usage of “first” and “second” herein above and below.

According to an embodiment, at 230, the modification action service receives an advertisement from the second project. The advertisement is for the first project to register for changes to the second resource or changes to the second project as a whole. In response, the modification action service registers for the changes with the second resource or the second project as a whole.

It is also noted that the modification action service can register for the notification in an unsolicited manner, such as what was discussed above with reference to the method 100 of the FIG. 1. Additionally, schema requirements or other policy restrictions can force registration of the notification.

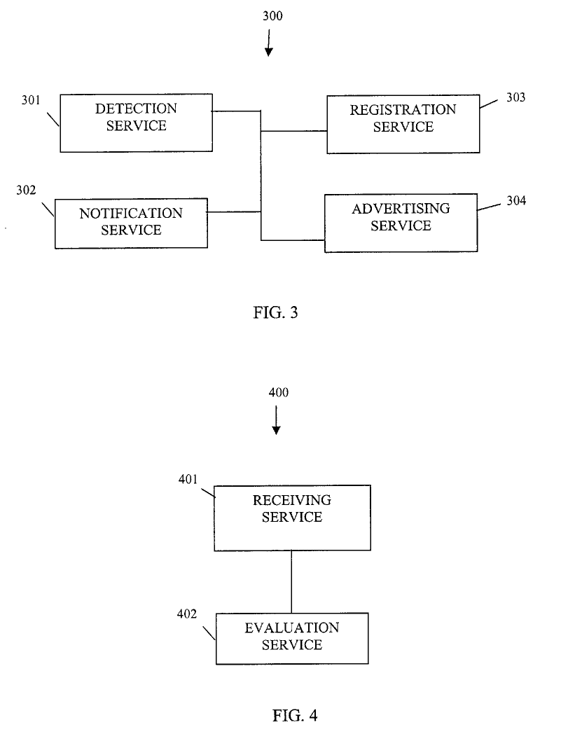

FIG. 3 is a diagram of a project modification detection and communication system 300, according to an example embodiment. The project modification detection and communication system 300 is implemented as instructions on or within a machine-accessible and readable medium. The instructions when executed by one or more machines perform various aspects of the processing depicted with respect to the method 100 of the FIG. 1. The project modification detection and communication system 300 is also operational over a network and the network may be wired, wireless, or a combination of wired and wireless.

The project modification detection and communication system 300 includes a detection service 301 and a notification service 302. In an embodiment, the project modification detection and communication system 300 also includes a registration service 303 and/or an advertising service 304. Each of these components and their interactions with one another will now be discussed in turn.

The detection service 301 is implemented in a machine-accessible and readable medium and is to process on a first machine associated with a first processing environment and a first stage of a first lifecycle for a first project. Example processing associated with the detection service 301 was described in detail above with reference to the detection and communication service represented by the method 100 of the FIG. 1.

The detection service 301 detects a modification occurring to a first resource within the first stage. Additionally, the detection service 301 reports the modification to the notification service 302. The detection service can use embedded triggers, events, or even monitor actions taken or actions taken against the first resource to detect the modifications. For example, the detection service 301 can detect an event associated with the modification where that event is raised within the first processing environment in response to a trigger associated with the first resource or associated with an action taken by the first resource.

The notification service 302 is implemented in a machine-accessible and readable medium and is to process on the first machine or a different machine within the first processing environment or a different processing environment. Example processing associated with the notification service 302 was described in detail above with reference to the detection and communication service represented by the method 100 of the FIG. 1.

The notification service 302 communicates the modification to a second project associated with a second stage of a second lifecycle for a second project. The second project processes and is managed in a second processing environment, which is external over a wide-area network from the first processing environment, such as over the Internet or the WWW.

In an embodiment, the notification service 302 uses policy in response to an identity associated with the second project to determine a communication mechanism to use for reporting the modification to the second project. Examples of such communication mechanisms were discussed in detail above with reference to the method 100 of the FIG. 1.

According to an embodiment, the notification service 302 access a schema associated with the first project and policy to resolve an identity, which is associated with the second project. Other mechanisms may exist as well to resolve the identity, such as a data structure, a third-party service, etc. These other mechanisms were discussed in detail above with reference to the method 100 of the FIG. 1.

The registration service 303 is implemented in a machine-accessible and readable medium and is to process on the first machine. Example processing associated with the registration service was described in detail above with reference to the detection and communication service represented by the method 100 of the FIG. 1.

The registration service 303 registers the second project for changes that are made to the first resource of the first project as a whole. Registration may be solicited or unsolicited. If unsolicited, security may be enforced to ensure registration is appropriate. Additionally, registration may be forced by schema restrictions and/or policy restrictions.

The advertising service 304 is implemented in a machine-accessible and readable medium and is to process on the first machine. Example processing associated with the advertising service 304 was described in detail above with reference to the detection and communication service represented by the method 100 of the FIG. 1.

The advertising service 304 advertises to the second project for purposes of seeing whether the second project desires to register for changes made to the first resource or to the first project as a whole, which includes the first resource.

FIG. 4 is a diagram of a project modification action system 400, according to an example embodiment. The project modification action system 400 is implemented as instructions on or within a machine-accessible and readable medium. The instructions when executed by a machine perform various aspects of the processing depicted with respect to the method 200 of the FIG. 2, and interact with the processing associated with the methods 200 of the FIG. 2 and the system 300 of the FIG. 3. The project modification action system 400 is also operational over a network and the network may be wired, wireless, or a combination of wired and wireless.

The project modification action system 400 includes a receiving service 401 and an evaluation service 402. Each of these components and their interactions with one another will now be discussed in turn.

The receiving service 401 is implemented in a machine-accessible and readable medium and is to process on a machine associated with a first processing environment and a first stage of a first lifecycle for a first project. Example processing of the receiving service 401 was described in detail above with reference to the method 200 of the FIG. 2.

The receiving service 401 processes a notification received from a second project, which is associated with a second processing environment. The notification is associated with a modification or change made to a second resource within a second stage of a second lifecycle for the second project. Moreover, the receiving service 401 delivers the notification to the evaluation service 402.

According to an embodiment, the modification is associated with one or more of the following: an upgrade to the second resource, a bug fix to the second resource, a change to a second policy that is the second resource, a change to configuration information associated with the second resource, a change to a digital certificate that is the second resource or is metadata associated with the second resource, a change to an attestation associated with the second resource, and/or a change to regulations or procedures associated with the second resource.

In an embodiment, the second resource is a newly introduced resource that was installed within the second processing environment. In another case, the second resource is an upgraded version of a previous resource that existed within the second processing environment. Of course, the resource can be a variety of no software type resources as well, such as policies, configuration information, content, digital signatures, keys, certificates, etc.

The evaluation service 402 is implemented in a machine-accessible and readable medium and is to process on the machine within the first processing environment. Example processing of the evaluation service 402 was described in detail above with reference to the method 200 of the FIG. 2.

The evaluation service 402 evaluates policy to take an action in response to the notification. The action can include, by way of example only, a variety of processing, such as taking no action by ignoring the notification, logging the notification, making a change to a first resource within the first stage that is equivalent to the modification, transitioning the first project to an entirely different stage of the first lifecycle, etc.

It is now appreciated how interdependencies between resources of different independent projects or even dependent projects can be achieved in an automated fashion. The relationships and processing can be done in dynamic and automated manners.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
detecting a modification to a resource of a first project, wherein the resource is within a stage of a lifecycle for the first project and within a processing environment;
determining a second project is to receive notification of the modification; and
communicating the notification regarding the modification to the second project.

2. The method of claim 1 further comprising, advertising to the second project to register for the notification before detecting the modification.

3. The method of claim 2 further comprising, registering in response to policy the second project for the notification before detecting the modification.

4. The method of claim 1 further comprising, receiving a registration from the second project for the notification before detecting the modification.

5. The method of claim 1 further comprising, forcing the second project to enter a particular stage of a second lifecycle for the second project in response to the notification.

6. The method of claim 1, wherein determining further includes one or more of the following:
evaluating a policy that indicates the second project is to receive the notification in response to the modification;
consulting a different resource for an identity of the second project in response to the modification; and
accessing a notification data structure with a modification identifier associated with the modification to acquire the identity for the second project.

7. The method of claim 1, wherein communicating further includes one or more of the following:
identifying a custom communication mechanism for communicating the notification to the second project via a policy;
establishing a World-Wide Web (WWW) services connection;
establishing a peer-to-peer transmission over a network to communicate the notification to the second project;
multicasting the notification over the network to the second project and one or more additional projects interested in the notification;
sending the notification via an email to a particular principal associated with the second project; and
posting the notification on a secure website accessible to the particular principal.

8. A method, comprising:
dynamically receiving, within a first processing environment associated with a first stage of a first lifecycle for a first project, a notification from a second project processing in a second processing environment, indicating that a second resource of the second project has been modified within a second stage of a second lifecycle for the second project; and
using a policy to determine an action to take within the first processing environment in response to the notification.

9. The method of claim 8 further comprising:
receiving an advertisement from the second project to register for changes to the second resource or the second project as a whole before dynamically receiving the notification; and
registering for the changes with the second resource or the second project as a whole.

10. The method of claim 8, wherein using further includes ignoring the notification, wherein an act of ignoring the notification is the action.

11. The method of claim 8, wherein using further includes backing the first project out of the first stage of the first lifecycle and first processing environment and transitioning the first project to a different stage of the first lifecycle in response to taking the action.

12. The method of claim 11, wherein backing further includes ensuring in response to a type of change associated with the second resource and the notification that the before the first project is permitted to re-enter the first stage that the first project undergo other stages associated with the first lifecycle for quality assurance, testing, and certification.

13. The method of claim 8, wherein using further includes making a change, which is equivalent to the modification made to the second resource, to a first resource associated with the first stage of the first project.

14. The method of claim 8, wherein dynamically receiving further includes recognizing the notification as including a type of change that represents the modification and a procedure for handling the change, and wherein the procedure includes an action identifier for the action.

15. A system, comprising:
a detection service implemented in a machine-accessible and readable medium and to process on a first machine associated with a first processing environment and a first stage of a first lifecycle for a first project; and
a notification service implemented in a machine-accessible and readable medium and to process on the first machine or a different machine within the first processing environment or a different processing environment; and
wherein the detection service is to detect a modification occurring to a first resource within the first stage and is to report the modification to the notification service, and wherein the notification service is to communicate the modification to a second project associated with a second stage of a second lifecycle for the second project, wherein the second project process in a second processing environment from the first processing environment.

16. The system of claim 15 further comprising, a registration service implemented in a machine-accessible and readable medium and to process on the first machine, wherein the registration service is to register the second project for changes made to the first resource or the first project as a whole.

17. The system of claim 15, an advertising service implemented in a machine-accessible and readable medium and to process on the first machine, wherein the advertising service is to advertise to the second project to register for changes made to the first resource or the first project as a whole.

18. The system of claim 15, wherein the notification service uses policy in response to an identity associated with the second project to determine a communication mechanism to use for reporting the modification to the second project.

19. The system of claim 15, wherein the notification service is to access a schema associated with the first project and policy to resolve an identity associated with the second project.

20. The system of claim 15, wherein the detection service detects an event associated with the modification and the event is raised within the first processing environment in response to a trigger associated with the first resource or associated with an action taken by the first resource.

21. A system, comprising:
a receiving service implemented in a machine-accessible and readable medium and to process on a machine associated with a first processing environment and a first stage of a first lifecycle for a first project; and
an evaluation service implemented in a machine-accessible and readable medium and to process on the machine within the first processing environment;
wherein the receiving service is to process a notification received from a second project associated with a second processing environment, wherein the notification is associated with a modification made to a second resource within a second stage of a second lifecycle for the second project, the receiving service delivers the notification to the evaluation service and the evaluation service evaluates policy to take an action in response to the notification.

22. The system of claim 21, wherein the second resource is a newly introduced resource that was installed within the second processing environment.

23. The system of claim 21, wherein the second resource is an upgraded version of a previous resource that existed within the second processing environment.

24. The system of claim 21, wherein the evaluation service is to take one or more of the following in response to the action: ignore the notification, log the notification, make a change to a first resource within the first stage that is equivalent to the modification, and transitioning the first project to a different stage of the first lifecycle.

25. The system of claim 21, wherein the modification is associated with one or more of the following: an upgrade to the second resource, a bug fix to the second resource, a change to a second policy that is the second resource, a change to configuration information associated with the second resource, a change to a digital certificate that is the second resource, a change to an attestation associated with the second resource, and a change to regulations or procedures associated with the second resource.
